(19) United States
(12) Patent Application Publication
(10) Pub. No.: US 2025/0229684 A1
(43) Pub. Date: Jul. 17, 2025

(54) FOLDABLE HEADREST SYSTEM FOR VEHICLE SEAT

(71) Applicant: GM GLOBAL TECHNOLOGY OPERATIONS LLC, Detroit, MI (US)

(72) Inventors: Sinhoon Kang, Paju-si (KR); Minsu Lee, Gyeonggi-do (KR); Jongsuk An, Seo-gu (KR)

(73) Assignee: GM GLOBAL TECHNOLOGY OPERATIONS LLC, Detroit, MI (US)

(21) Appl. No.: 18/411,767

(22) Filed: Jan. 12, 2024

(51) Int. Cl. B60N 2/844

(52) U.S. Cl. CPC B60N 2/844

(57) ABSTRACT

A foldable headrest for a vehicle seat includes a headrest assembly including a headrest and a frame with a section. A housing has a pair of side plates, each with a with a groove, and the section of the frame extends through the grooves. A rotating plate is engageable with the section of the frame. A lock lever is engageable with the rotating plate to hold the rotating plate and the headrest in position. A link/cable is connected with the lock lever to move the lock lever to allow the rotating plate and the headrest assembly to rotate.

### INTRODUCTION

The present disclosure generally relates to foldable vehicle seats and more particularly relates to foldable headrests for foldable vehicle seats.

On vehicle seats, a head restraint may extend upward from a seat's back. The seat back may be selectively moved between a generally upright use position and a retracted stowed or storage position. In some applications this may be referred to as a fold flat seat, which may be advantageous for a variety of reasons. For example, it may be desirable to provide cargo carrying space or to increase accessibility to the inside of the vehicle by moving the seat and stowing it in a minimized package space.

The ability to fold the vehicle seat within the constraints of a vehicle is limited by the size of the seat and its features. For example, if left in place, the headrest requires substantial space when folding the seat back. Typically, seat rows behind the driver seat and the front passenger seat are desirably foldable. The presence of the driver seat and the front passenger seat (or any forward seat row), limits the available space for folding the rear seat. In some applications the headrest of the rear seats is removeable to facilitate folding.

Vehicle seats having foldable head restraints enable folding without removing the head restraint. However, these foldable head restraints still require substantial clearance to operate. It would be advantageous to provide a vehicle seat having a seat back with a foldable head restraint that requires a minimum of clearance space to forward objects such as other seats.

Accordingly, it is desirable to provide vehicle seats with components that meet fold-flat requirements and/or require minimal clearance for use in various applications. Furthermore, other desirable features and characteristics of the present invention will become apparent from the subsequent detailed description and the appended claims, taken in conjunction with the accompanying drawings and the foregoing introduction.

### SUMMARY

Headrest systems are provided for folding seats. In a number of embodiments, a foldable headrest for a vehicle seat includes a headrest assembly including a headrest and a frame with a section. A housing has a pair of side plates, each with a groove, and the section of the frame extends through the grooves. A rotating plate is engageable with the section of the frame. A lock lever is engageable with the rotating plate to hold the rotating plate and the headrest in position. A link is connected with the lock lever to move the lock lever to allow the rotating plate and the headrest assembly to rotate.

In additional embodiments, a spring urges the headrest assembly toward a folded position.

In additional embodiments, the rotating plate includes a lock, and the lock lever includes a catch that engages the lock.

In additional embodiments, the housing includes a connection plate connecting with the first side plate and with the second side plate.

In additional embodiments, a torsion spring engages the lock lever to urge the lock lever toward the rotating plate.

In additional embodiments, the housing includes a bottom plate connecting with the first side plate and with the second side plate.

In additional embodiments, the frame is U-shaped and the section is straight.

In additional embodiments, the vehicle seat has a back and the housing is connected to the back.

In additional embodiments, a guide has a receiver that receives the section and biases the headrest assembly to a folded position.

In a number of additional embodiments, a foldable headrest system for a vehicle seat includes a headrest assembly that has a headrest and a frame that has a section. A housing has one side plate with a groove and another side plate with another groove. The section of the frame extends through both grooves. A rotating plate is engageable with the section of the frame when the headrest assembly in in an upright position. A lock lever is engageable with the rotating plate to hold the rotating plate and the headrest in the upright position. A link is connected with the lock lever to move the lock lever to allow the rotating plate and the headrest assembly to rotate.

In additional embodiments, a torsion spring urges the headrest assembly toward a folded position.

In additional embodiments, the rotating plate includes a lock shaped as a tooth and the lock lever includes a catch that is engageable with the lock.

In additional embodiments, the housing includes a front connection plate connecting with the first side plate and with the second side plate.

In additional embodiments, a pin holds the lock lever to the housing. A spring on the pin engages the lock lever.

In additional embodiments, a torsion spring engages the lock lever to urge the lock lever toward the rotating plate.

In additional embodiments, the housing includes a bottom plate connecting with the first side plate and with the second side plate. The housing includes a support for supporting the frame.

In additional embodiments, the frame is U-shaped and the section is straight. The frame includes a pair of legs extending from the section to the headrest.

In additional embodiments, the vehicle seat has a back and the housing is contained in the back.

In a number of other embodiments, a foldable headrest system for a vehicle seat includes a headrest assembly including a headrest and a frame with a section. A housing has a pair of side plates, each of which has a groove. The section of the frame extends through both grooves. The housing includes a connecting plate that connects with both side plates. A rotating plate is included, and the section of the frame is extendable through the rotating plate. A lock lever is engageable with the rotating plate to hold the rotating plate and the headrest in an upright position. A link is connected with the lock lever to move the lock lever to allow the rotating plate and the headrest assembly to rotate to a folded position.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic diagram of a part of a vehicle with a seat that has a folding headrest system, in accordance with various embodiments;

FIG. 2 is an exploded, perspective illustration of a headrest system for the vehicle seat of FIG. 1, in accordance with various embodiments;

FIG. 3 is a schematic, partially sectioned illustration of the headrest system of FIG. 2, with the headrest in an upright position, in accordance with various embodiments;

FIG. 4 is a schematic, partially sectioned illustration of the headrest system of FIG. 2 with the headrest in a folded position, in accordance with various embodiments;

FIG. 5 is an exploded, perspective illustration of a headrest system for the vehicle seat of FIG. 1, in accordance with various embodiments;

FIG. 6 is a schematic, partially sectioned illustration of the headrest system of FIG. 5, with the headrest in an upright position, in accordance with various embodiments; and

FIG. 7 is a schematic, partially sectioned illustration of the headrest system of the seat of FIG. 1 with the headrest in a folded position, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description.

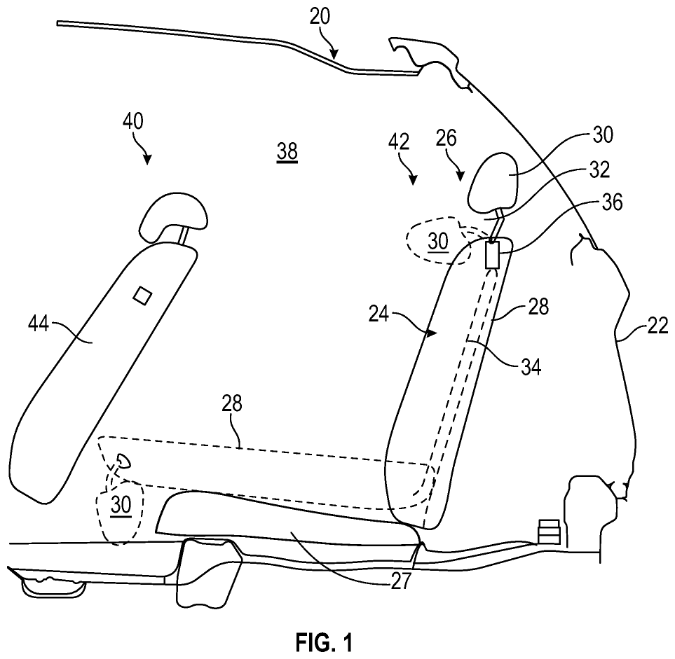

With reference to FIG. 1, illustrated is one example of a vehicle 20 having a body 22 on which a seat 24 is mounted. In general, the seat 24 has a seat bottom 27, a seat back 28 and a head restraint system 26. The head restraint system 26 is connected with the seat back 28. For example, a frame 32 connects with a headrest 30 of the head restraint system 26 and with a structural member 34 in the seat back 28, such as through a mechanism 36, and provides support to the head restraint system 26.

As depicted in FIG. 1, the body 22 of the vehicle 20 is supported on wheel assemblies (not shown), such as by a suspension assembly (not shown). The body 22 may be of various types that define a physical shape for desired purposes. The body 22 substantially encloses components of the vehicle 20, defines exterior surfaces, and defines an interior 38. The wheel assemblies may each be rotationally coupled near a respective corner of the body 22. In various embodiments, the vehicle 20 may be a front wheel drive vehicle, a rear wheel drive vehicle, or an all-wheel drive vehicle with any number of wheels, however other drive arrangements are contemplated.

Propulsion of the vehicle 20, such as on a roadway, is provided by a propulsion system (not shown). The propulsion system may be any of various types such as electric, internal combustion, hybrid, or others. Torque generated by the propulsion system is transferred to the wheel assemblies to propel the vehicle 20, which may be done under manual and/or autonomous control.

In the embodiment illustrated in FIG. 1, the interior 38 of the vehicle 20 includes a front seat row 40 and a rear seat row 42. In other embodiments, additional seat rows may be included. The front seat row 40 includes a seat with seat back 44 that is generally intended to remain upright as shown during operation of the vehicle 20. The rear seat row 42 includes the seat 24, which is operable to fold (through steps) as indicated by the dashed lined versions. When the seat 24 is folded, if the head restraint system 26 remained in its upright position its trajectory would restrict movement of the seat back 28 by interfering with the seat back 44. Accordingly, the head restraint system 26 is foldable as shown in dashed lines. To maximize the applications within which the seat 24 is foldable, and to minimize the need to move the seat back 44 forward, the head restraint system 26 folds in a way that requires a minimum of forward space.

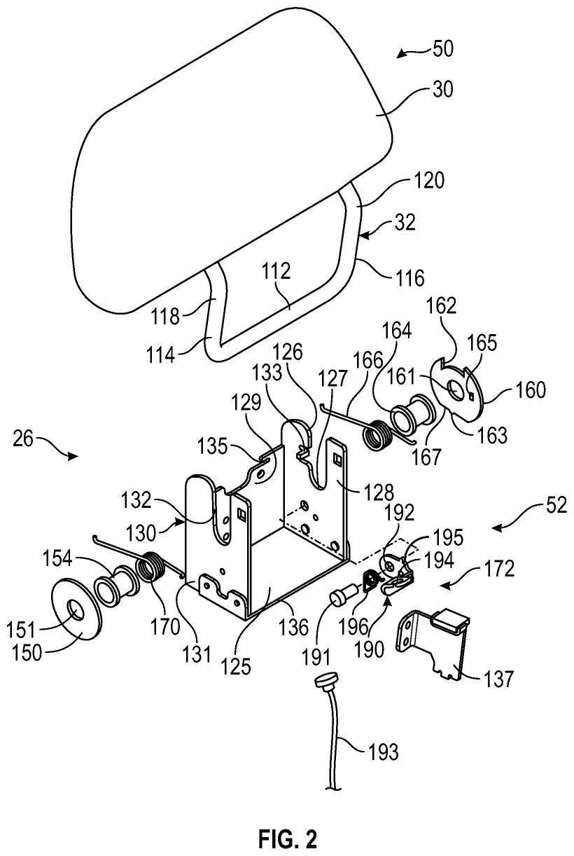

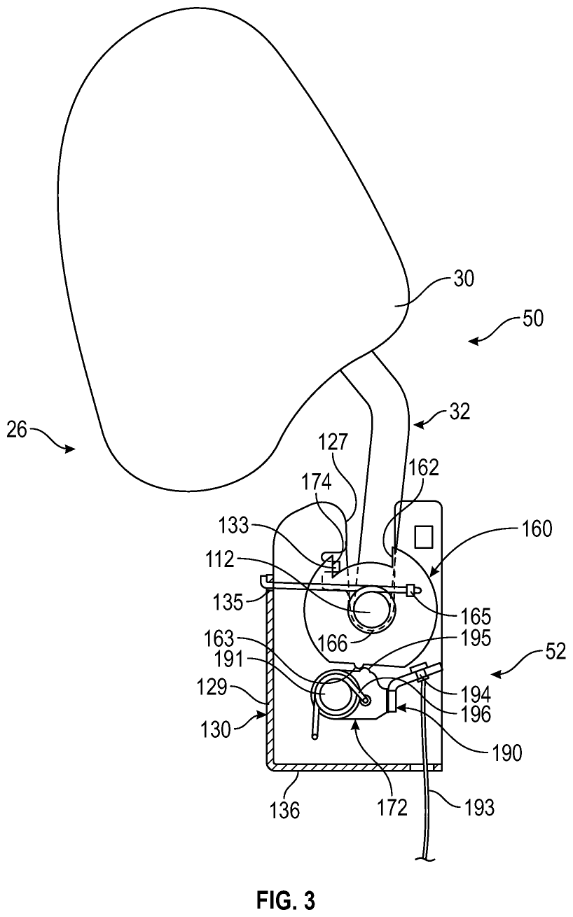

Referring to FIGS. 2 and 3, along with FIG. 1, an embodiment of the head restraint system 26 is illustrated. The head restraint system 26 generally includes a headrest assembly 50 and a folding assembly 52 as the mechanism 36 of FIG. 1. The headrest assembly 50 includes the headrest 30 and the frame 32. The frame 32 is configured to connect the headrest 30 to the folding assembly 52. In this embodiment, the frame 32 is formed from a rod and has a center section 112 that is straight, and a pair of legs 114, 116 extending from the center section 112 into the headrest 30. The frame 32 has a U-shape. The center section 112 is configured for connection with the folding assembly 52. The legs 114, 116 have bends 118, 120 that are bent at an obtuse angle to place the headrest 30 in a more forward position relative to the folding assembly 52 and to facilitate folding.

The folding assembly 52 connects the headrest assembly 50 to the structural member 34 (shown in FIG. 1) and allows the headrest assembly 50 to fold between an upright position and a folded position. The folding assembly 52 includes a housing 130 with side plates 128, 131, a connection plate 129, and a bottom plate 136. The bottom plate 136 is fixed to the structural member 34 (FIG. 1). The housing 130 is a box- like structure with four closed sides defining an interior space 125. The side plate 128 includes a coupling groove 127 and the side plate 131 includes another coupling groove 132. The coupling grooves 127, 132 receive the center section 112 (FIG. 3). The coupling groove 132 is formed as a blind-ended slot in the side plate 131 that is U-shaped. The coupling groove 127 is formed as a blind-ended slot in the side plate 128 that is U-shaped with a stop 133 formed on its forward side 126 and extending into the interior space 125. The stop 133 is formed from the material of the side plate 128 and is L-shaped. The stop 133 provides a limit for folding movement of the headrest assembly 50 as described in more detail below. A support 137 is configured to be disposed in the interior space 125 and to support the center section 112 and therethrough, the headrest assembly 50.

The center section 112 will extend through the coupling grooves 127, 132. The center section 112 will also extend through a fixing hole 151 of a rotating plate 150, through a bushing 154, and through a torsion spring 170. The bushing 154 is configured to sit in the blind end of the coupling groove 132. The torsion spring 170 is configured to engage the housing 130 the rotating plate 160, such as through a tab, and biases the headrest assembly 50 toward the folded position. The center section 112 will also extend through a fixing hole 161 of a rotating plate 160, a bushing 164, and a torsion spring 166. As a result, the center section 112 engages the rotating plates 150 and 160, in this case within the fixing holes 151 and 161 so that the headrest assembly 50 rotates with the rotating plates 150 and 160. The bushing 164 is configured to sit in the blind end of the coupling groove 127 as shown in FIG. 3. The torsion spring 166 is configured to engage the housing 130 in a groove 135 and a tab 165 of the rotating plate 160 and biases the headrest assembly 50 toward the folded position.

The rotating plate 150 is formed as an annular, washer-like element. The rotating plate 160 is formed as an annular washer-like element with a flat side 167 and a locking groove 162 on an opposite side of the fixing hole 161 from the flat side 167. The locking groove 162 receives the stop 133 as shown in FIG. 3 to allow movement of the headrest assembly 50 between the upright position and the folded position. A lock 163 extends radially outward from the rotating plate 160 in the middle of the flat side 167 in the form of a pointed tip. The lock 163 is configured to engage a lock assembly 172 as shown in FIG. 3 and may be shaped as a tooth or teeth.

The folding assembly 52 includes the lock assembly 172. The lock assembly 172 includes a fixing member in the form of a lock lever 190. In general, the lock lever 190 engages the rotating plate 160 to alternately lock and release it in regard to rotation. A torsion spring 196 engages the lock lever 190 and the housing 130 to bias the lock lever 190 to a locking position. A pin 191 extends through the torsion spring 196 and through a coupling hole 192 of the lock lever 190 and engages the housing 130 to hold the lock lever 190 in position, while allowing it to rotate. The lock lever 190 includes a fixing protrusion in the form of a catch 195 that is a type of pointed tip for engaging the lock 163 as shown in FIG. 3. A link 193, in the form of a cable in this embodiment, engages the lock lever 190, such as in an opening 194, and at its other end is connected to the seat 24 to release the lock lever 190 when the seat 24 is folded or triggered for folding. In other embodiments, the link 193 may be one or more rods, levers, arms, strands, ties, or a combination thereof.

As illustrated in FIG. 3, the headrest assembly 50 is shown in an upright and locked condition. The end 174 of the locking groove 162 is disposed against the stop 133 defining the position's location. The torsion spring 166 applies a force to rotating plate 160 (and the torsion spring 170 applies a force to the rotating plate 150), and therethrough to the center section 112 in a counterclockwise direction as viewed. The torsion spring 196 applies a force to the lock lever 190 in a counterclockwise direction as viewed to hold the catch 195 against the lock 163 to hold the rotating plate 160 and the headrest assembly 50 in position.

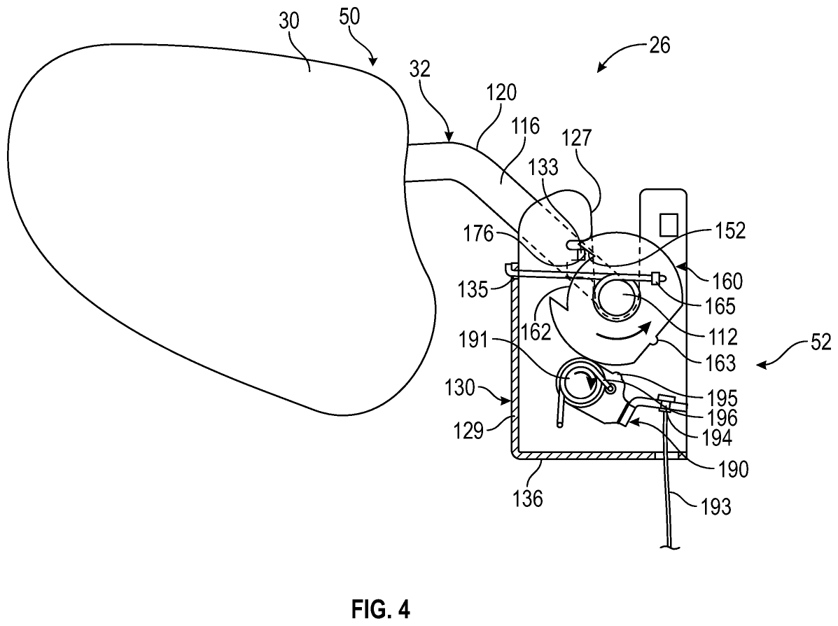

As shown in FIG. 4, the headrest assembly 50 is shown in a folded position. The cable (link 193) has applied a pulling force to the lock lever 190 rotating it in a clockwise direction as viewed against the force of the torsion spring 196. This pulls the catch 195 away from the lock 163 allowing the torsion spring 166 to rotate the headrest assembly 50, via the rotating plate 160 (and similarly through the rotating plate 150 under force of the torsion spring 170). The headrest assembly 50 and the rotating plate 160 move until the end 176 of the locking groove 162 engages the stop 133 defining the folded position. Maintaining a fixed pivot point of the headrest assembly 50 at the center of the center section 112 and the angle of the bend 120 of the leg 116 minimizes the distance that the headrest 30 extends forward to provide clearance for folding of the seat 24.

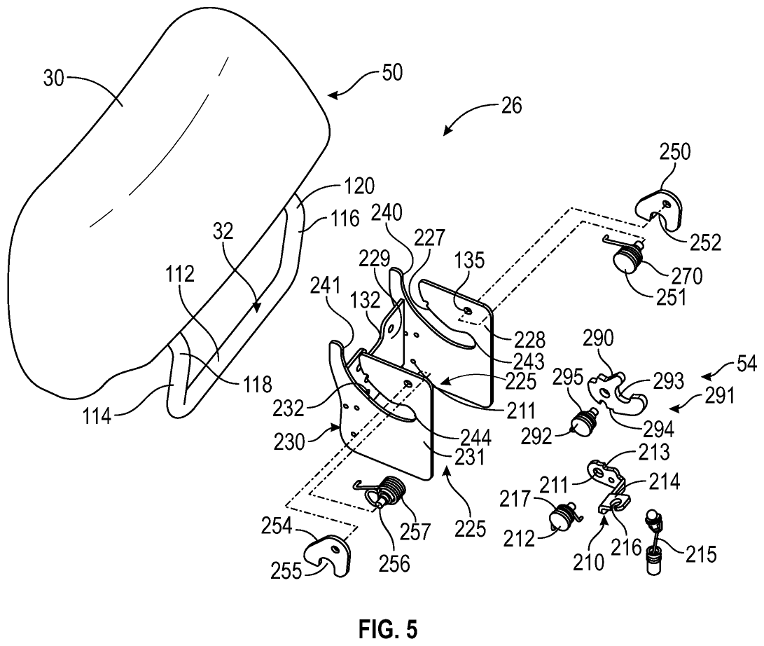

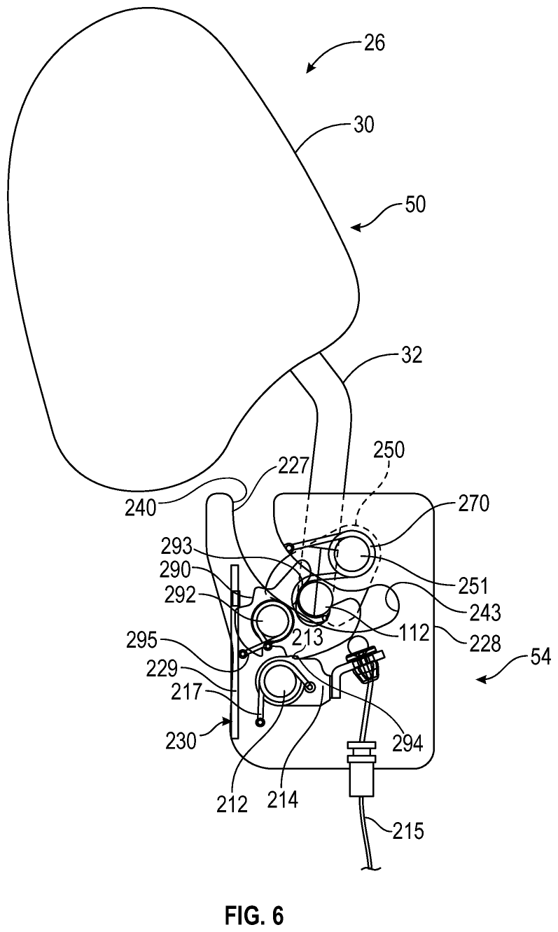

Referring to FIGS. 5 and 6, along with FIG. 1, an embodiment of the head restraint system 26 is illustrated. The head restraint system 26 generally includes the headrest assembly 50 and a folding assembly 54 as the mechanism 36 of FIG. 1. The headrest assembly 50 includes the headrest 30 and the frame 32. The frame 32 is configured to connect the headrest 30 to the folding assembly 54. In this embodiment, the frame 32 is formed from a rod and has a center section 112 that is straight, and a pair of legs 114, 116 extending from the center section 112 into the headrest 30. The center section 112 is configured for connection with the folding assembly 54. The legs 114, 116 have bends 118, 120 that are bent at an obtuse angle to place the headrest 30 in a more forward position relative to the folding assembly 54.

The folding assembly 54 connects the headrest assembly 50 to the structural member 34 (shown in FIG. 1) and allows the headrest assembly 50 to fold between an upright position and a folded position. The folding assembly 54 includes a housing 230 with side plates 228, 231, and a connection plate 229. The side plates 228, 231 may be fixed to the structural member 34 (FIG. 1). The housing 230 is a box-like structure with three closed sides defining an interior space 225. The side plate 228 includes a guide groove 227 and the side plate 231 includes a guide groove 232. The guide grooves 227, 232 receive the center section 112 (FIG. 6). The guide grooves 227, 232 are each formed as blind-ended slots in the side plates 228, 231. The guide grooves 227, 232 have mouths 240, 241 that open near the forward side of the housing 230 adjacent the connection plate 229 and the guide grooves 227, 232 curve rearward to their ends 243, 244 in arc shapes.

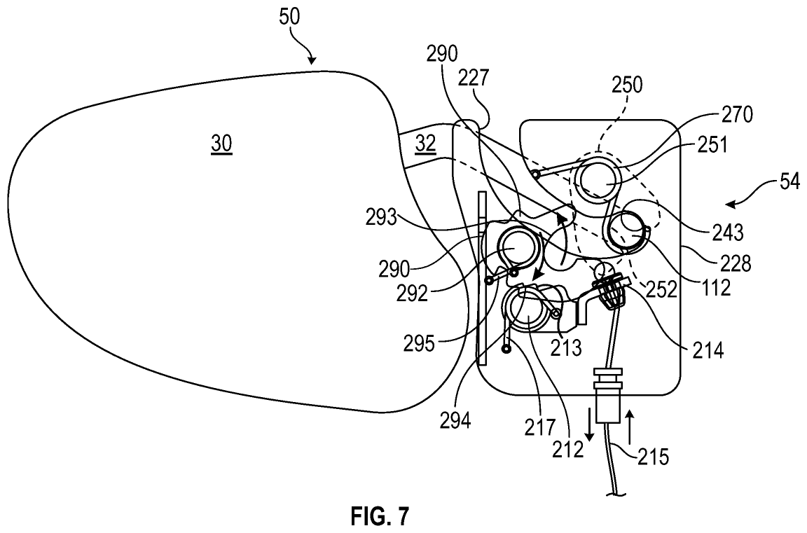

The center section 112 will extend through the guide grooves 227, 232. A guide 250 includes a receiver 252 and is rotatably fixed to the side plate 228 by a pin 251 that passes through a torsion spring 270. Another guide 254 includes a receiver 255 and is fixed to the side plate 231 by a pin 256 that passes through a torsion spring 257. The center section 112 is straight and extends through the receivers 252, 255 as shown in FIG. 6. The torsion springs 270, 257 engage the housing 230 and the center section 112 and bias the headrest assembly 50 toward the folded position of FIG. 7.

A rotating plate 290 is fixed to the side plate 228 by a pin 292. The pin 292 passes through a torsion spring 295. The rotating plate 290 includes an aperture 293. The rotating plate 290 includes a lock jaw in the form of a lock 294. The lock 294 may be shaped as a tooth or teeth. The folding assembly 54 includes a lock assembly 291. The lock assembly 291 includes a fixing member 210 in the form of a lock lever 214. In general, the lock lever 214 engages the rotating plate 290 to alternately lock and release it in regard to rotation. A torsion spring 217 engages the lock lever 214 and the housing 230 to bias the lock lever 214 to a locking position. A pin 212 extends through the torsion spring 217 and a coupling hole 211 of the lock lever 214 and engages the housing 230 to hold the lock lever 214 in position, while allowing rotation. The lock lever 214 includes a fixing protrusion in the form of a catch 213 that is a type of pointed tip or tips for engaging the lock 294 as shown in FIG. 6. A link 215, in the form of a cable in this embodiment, engages the lock lever 214 and at its other end is connected to the seat 24 to release the lock lever 214 when the seat 24 is folded.

As illustrated in FIG. 6, the headrest assembly 50 is shown in an upright and locked condition. The center section 112 is trapped in the aperture 293 of the rotating plate 290, which places the headrest 30 in its upright position. The torsion spring 217 applies a force to urge the lock lever 214 in a counterclockwise direction as viewed. This ensures the lock lever 214 engages the rotating plate 290 with the catch 213 engaging the lock 294 to hold the rotating plate 290 and the headrest assembly 50 in position.

As shown in FIG. 7, the headrest assembly 50 is shown in a folded position. The cable (link 215) has applied a pulling force to the lock lever 214 rotating it in a clockwise direction as viewed against the force of the torsion spring 217. This pulls the catch 213 out of the lock 294 allowing the torsion spring 170 step along the catch 213 so that the lock lever 214 and the rotating plate 290 rotate clockwise as shown. This allows the headrest assembly 50 to rotate as the rotating plate 290 moves and releases the center section 112. The center section 112 moves out of the aperture 293. The headrest assembly 50 moves until the center section 112 reaches the end 243 of the guide groove 227 and the end 243 acts as stop defining the folded position. The headrest assembly 50 may be returned to the upright position manually when the seat 24 is unfolded. The center section 112 remains in the receivers 252, 255 of the guides 250, 254 and the torsion springs 270, 257 bias the center section 112 to the end 243.

When folding the seat 24, there is no need to remove the headrest 30 because the folding trajectory of the headrest assembly 50 clears the forward seat back 44. When the seat 24 is folded, the headrest 30 rotates to its folded position. By improving the headrest folding pivot point, the overall back folding trajectory is reduced, thereby providing advantages in terms of vehicle package. A fold flat function may be applied because interference with the front seat is avoided. A fold flat function provides advantages for loading cargo.

Accordingly, a folding seat is provided with a folding headrest that requires less space to operate. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A foldable headrest system for a vehicle seat comprising:
a headrest assembly including a headrest and a frame with a section;
a housing having a first side plate with a first groove and a second side plate with a second groove, with the section of the frame extending through the first groove and through the second groove;
a rotating plate engageable with the section of the frame;
a lock lever engageable with the rotating plate to hold the rotating plate and the headrest in position; and
a link connected with the lock lever to move the lock lever to allow the rotating plate and the headrest assembly to rotate.

2. The foldable headrest system of claim 1, comprising a spring urging the headrest assembly toward a folded position.

3. The foldable headrest system of claim 1, wherein the rotating plate includes a lock and the lock lever includes a catch configured to engage the lock.

4. The foldable headrest system of claim 1, wherein the housing includes a connection plate connecting with the first side plate and the second side plate.

5. The foldable headrest system of claim 1, comprising a pin holding the lock lever to the housing.

6. The foldable headrest system of claim 1, comprising a torsion spring engaging the lock lever to urge the lock lever toward the rotating plate.

7. The foldable headrest system of claim 1, wherein the housing includes a bottom plate connecting with the first side plate and with the second side plate.

8. The foldable headrest system of claim 1, wherein the frame is U-shaped and the section is straight.

9. The foldable headrest system of claim 1, wherein the vehicle seat has a back and the housing is connected to the back.

10. The foldable headrest system of claim 1, comprising a guide with a receiver that receives the section and biases the headrest assembly to a folded position.

11. A foldable headrest system for a vehicle seat comprising:
a headrest assembly including a headrest and a frame that has a section;
a housing having a first side plate with a first groove and a second side plate with a second groove, with the section of the frame extending through the first groove and through the second groove;
a rotating plate engageable with the section of the frame when the headrest assembly in in an upright position;
a lock lever engageable with the rotating plate to hold the rotating plate and the headrest in the upright position; and
a link connected with the lock lever to move the lock lever to allow the rotating plate and the headrest assembly to rotate.

12. The foldable headrest system of claim 11, comprising a torsion spring urging the headrest assembly toward a folded position.

13. The foldable headrest system of claim 11, wherein the rotating plate includes a lock shaped as a tooth and the lock lever includes a catch configured to engage the lock.

14. The foldable headrest system of claim 11, wherein the housing includes a front connection plate connecting with the first side plate and the second side plate.

15. The foldable headrest system of claim 11, comprising a pin holding the lock lever to the housing, with a spring on the pin and engaging the lock lever.

16. The foldable headrest system of claim 11, comprising a torsion spring engaging the lock lever to urge the lock lever toward the rotating plate.

17. The foldable headrest system of claim 11, wherein the housing includes a bottom plate connecting with the first side plate and with the second side plate, and includes a support for supporting the frame.

18. The foldable headrest system of claim 11, wherein the frame is U-shaped and the section is straight, wherein the frame includes a pair of legs extending from the section to the headrest.

19. The foldable headrest system of claim 11, wherein the vehicle seat has a back and the housing is contained in the back.

20. A foldable headrest system for a vehicle seat comprising:
a headrest assembly including a headrest and a frame with a section;
a housing having a first side plate with a first groove and a second side plate with a second groove, with the section of the frame extending through the first groove and through the second groove, the housing including a connecting plate that connects with the first side plate and the second side plate;
a rotating plate, through which the section of the frame is extendable;
a lock lever engageable with the rotating plate to hold the rotating plate and the headrest in an upright position; and
a link connected with the lock lever to move the lock lever to allow the rotating plate and the headrest assembly to rotate to a folded position.
